(19) United States
(12) Patent Application Publication
(10) Pub. No.: US 2007/0030880 A1
(43) Pub. Date: Feb. 8, 2007

(54) Gold tip thermometer

(75) Inventors: Jody Smith, New York, NY (US); Andrew Howansky, Copake Falls, NY (US); Stephen Russak, Fort Lee, NJ (US); Christopher Craig, New York, NY (US)

Correspondence Address: DARBY & DARBY P.C., P. O. BOX 5257, NEW YORK, NY, 10150-5257, US

(73) Assignee: Kaz, Incorporated, New York, NY (US)

(21) Appl. No.: 11/197,947

(22) Filed: Aug. 4, 2005

(51) Int. Cl. G01K 1/00

(52) U.S. Cl. 374/208

(57) ABSTRACT

A thermometer having a temperature sensing element connected to a processor and a display. The processor can receive signals from the temperature sensing element related to the temperature of a patient. The processor and temperature sensing element are enclosed within in the thermometer. The temperature sensing element is adjacent a highly conductive cover defining a temperature probe. The temperature probe includes gold or gold alloy on an outer surface thereof. The outer surface contacts the user and the gold covered probe acts as a hypoallergenic heat transfer element between the user and the temperature sensing element. The gold tip can be used with a glass-tube thermometer or an electronic thermometer.

### BACKGROUND OF THE INVENTION

1. Field of the Invention

The present invention relates to a thermometer for detecting and displaying a user's body temperature. More particularly, the present invention pertains to a clinical thermometer with a temperature probe having an outer surface of gold or gold alloy.

2. Discussion of the Related Art

There are multiple types of thermometers, including hand held electronic thermometers and glass-tube mercury thermometers. The glass-tube mercury thermometers have gradated scales colored or etched into the glass tube and once the mercury rises and settles in the glass tube due to the temperature of the patient, a user can read the temperature from the scale, calibrated for Fahrenheit or Centigrade. Conventional glass-tube thermometers have long response times and can take several minutes to acquire an accurate reading.

As an improvement, hand held electronic thermometers were introduced. In the basic electronic thermometer design, a temperature sensing element is connected to a combined, battery-powered computing and display element. The temperature sensing element is placed in a temperature sensing region of the thermometer and has a protective cover enclosing the temperature sensing element inside the thermometer. The cover of the temperature sensing element defines a temperature probe for reading the temperature of a patient. In a conventional electronic oral thermometer, the probe is formed of a metal and is placed towards a distal tip of the thermometer. In use, the temperature probe absorbs heat from the user via the temperature sensing element and an electronic circuit determines and displays the temperature of the probe. Most current electronic thermometers have a response time that is well under one minute. The thermometer's response time is largely dependant on the thermal conductivity of the probe and the type of sensing element. The temperature probe of most electronic thermometers is formed of nickel because of its high thermal conductivity and relatively low cost compared to other highly conductive metals (e.g., platinum).

Conventional electronic thermometers, though quick and accurate, have a major drawback. Nickel is a highly allergenic metal. Nickel allergies can cause dermatitis and considerable discomfort. In many cases, only brief contact is needed for the sufferer to experience a reaction. Thus, a significant percentage of the population is allergic to the temperature probe of conventional electronic thermometers.

As an alternative, some thermometers have stainless steel covered probes. Stainless steel is hypoallergenic and poses no threat to those with metal allergies. However, stainless steel has a very low thermal conductivity compared to other metals and its use in thermometers increases the time needed for an accurate measurement.

Other available options for those with a nickel allergy are also not desirable. For example, most conventional glass-tube thermometers have also adopted the practice of covering the probe tip with nickel and/or stainless steel, which may be used by those with nickel allergies. Additionally, glass-tube thermometers contain mercury, a known poison. If a glass-tube thermometer is broken during use, the user risks harm from the broken glass and the mercury. Further, glass-tube thermometers are slow and the temperature taking process is cumbersome. Both the glass itself and the stainless steel probe cover have low thermal conductivity.

Another option for users with nickel allergies is to use a plastic guard placed over the temperature probe. However, plastic guards make the temperature taking process more difficult, as the thermometer may slip out of the guard and fall out of the user's mouth. In addition, the guards may be displaced or their supply exhausted requiring the user to purchase more guards.

Thus, there is a need in the art for a low cost, hypoallergenic, thermometer with a highly conductive probe.

### SUMMARY OF INVENTION

A hand held electronic thermometer for use with a living being in accordance with the present invention is illustrated. The thermometer is formed of a plastic case having a probe section and a body section. A display is disposed on the body section to display temperatures. The temperature sensing element is mounted in the end of the probe section and covered with a thermally conductive cap which defines a temperature probe of the thermometer. The body section may also include a power/activation button.

The temperature probe of the claimed thermometer includes gold. Specifically, an outer surface of the temperature probe can be formed of pure gold or a high purity gold alloy. The purity of the gold can be such that it may be considered hypoallergenic. In use, the thermometer poses no threat to those with metal allergies because of the hypoallergenic outer probe surface. Further, the gold outer surface can extend to a proximal section adjacent to the plastic case to ensure the patient only contacts the plastic or the gold probe.

One embodiment of the temperature probe includes the outer gold surface surrounding an inner support of a different material than that of the gold outer surface. The inner support serves multiple purposes. The inner support may be harder than gold, providing structural support for the temperature probe. In use, the probe may be placed in the user's mouth and should be adequately constructed to sustain any biting by the user. The inner support should be formed to withstand all appropriate forces that may be incurred by a thermometer. Further, the inner support, like the gold outer surface, may have a high thermal conductivity allowing fast readings to be made by the thermometer. Also, the material of the inner support may be substantially cheaper than gold and using a gold outer surface around the inner support may reduce the cost of the temperature probe.

Alternatively, the entire temperature probe may be formed of gold or a gold alloy. In this embodiment the gold should be of a composition such that it is hypoallergenic, but also has adequate structural properties for use in the temperature probe of the thermometer.

The types of gold used for the temperature probe can be pure gold, or a gold alloy. Pure gold is very soft and must be thick to have enough hardness to sustain a theoretical maximum biting force of the patient. A thick temperature probe can be used but can increase the size of the temperature probe and cost more to manufacture.

Gold is mixed with other metals to make gold alloy which has a higher hardness relative to pure gold. The most common metals to alloy with gold are copper and silver, but nickel, palladium, zinc, and other metals are used.

In the present invention, an embodiment uses copper, silver or zinc as the alloy metal with gold and not nickel. Typical allergies to gold stem from low karat gold with a nickel alloy. High karat gold, e.g. 18 and 22 karats, contains a high percentage of gold in the alloy to minimize the effects of the additional metal. Further, gold alloy is harder than pure gold.

As an example, typical 18 karat gold alloy has a hardness which is two to three times harder than (almost) pure gold. The higher the hardness, the better the gold probe withstands biting forces.

The hypoallergenic gold covered temperature probe is not limited to use in oral thermometers. Those with metal allergies have a reaction when allergenic metals contact any exposed surface of their bodies. Thus, a temperature probe with an outer surface of gold is also advantageous for use in rectal and axillary thermometers. An embodiment of the invention can be used for a gold covered temperature probe of a glass-tube thermometer.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a perspective view of an embodiment of the gold tip thermometer of the present invention;

FIG. 2 is a top view of the embodiment illustrated in FIG. 1;

FIG. 3 is a right side view of the embodiment illustrated in FIG. 1; and

FIG. 4 is a cross-sectional view taken along lines 4-4 of FIG. 2 of the temperature probe tip.

### DETAILED DESCRIPTION OF THE PREFERRED EMBODIMENT

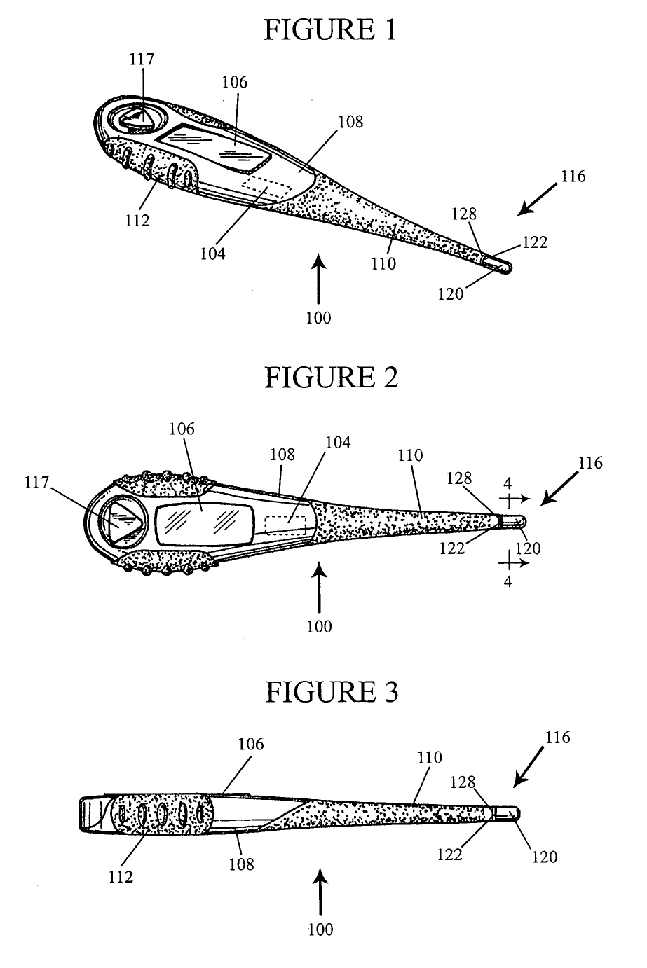

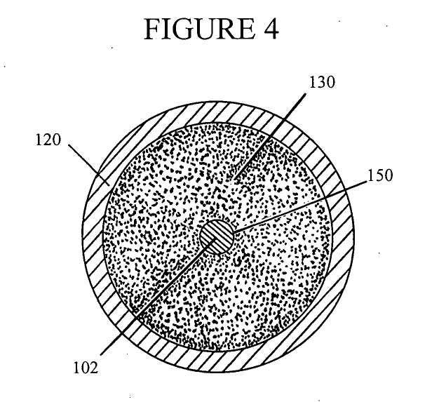

Referring to FIGS. 1, 2 and 3, an embodiment of a hand held electronic thermometer 100 for use with a living being and in accordance with the present invention is illustrated. The thermometer 100 is formed of a plastic case 108 having a probe section 110 and a body section 112. A display 106 is disposed on the body section 112 to display temperatures. A battery (not shown), processor 104 and temperature sensing element 102 (as in FIG. 4) are housed within plastic case 108. The temperature sensing element 102 is mounted in the end of probe section 110 and covered with a thermally conductive cap which defines a temperature probe 116 of thermometer 100. Body section 112 may also include a power/activation button 117.

The temperature probe 116 of the thermometer 100 includes gold. Specifically, an outer surface 120 of temperature probe 116 can be formed of pure gold or a high purity gold alloy. The purity of the gold can be such that it may be considered hypoallergenic. In use, the thermometer poses no threat to those with metal allergies because of its hypoallergenic outer probe surface 120.

Temperature probe 116 includes a proximal face 122 adjacent a distal end 128 of plastic case 108. The gold outer surface 120 extends to proximal face 122 of temperature probe 116, such that no allergenic metals within thermometer 100, and specifically within temperature probe 116, contact the user. Thus, the thermometer provides a safe alternative to conventional electronic thermometers for those allergic to metals, specifically nickel.

As shown in FIG. 4, one embodiment of temperature probe 116 includes an inner support 130 of a different material than that of gold outer surface 120. Inner support 130 serves multiple purposes. The inner support 130 may be harder than gold, providing structural support for temperature probe 116. In use, probe 116 may be placed in the user's mouth and should be adequately constructed to sustain any biting by the user. Inner support 130 should be formed to withstand all appropriate forces that may be experienced by a thermometer. Further, inner support 130, like gold outer surface 120, may have a high thermal conductivity allowing fast readings to be made by thermometer 100. Also, the material of inner support 130 may be substantially cheaper than gold and using a gold outer surface 120 around inner support 130 may achieve the advantages of the present invention but reduce the cost of temperature probe 116. In a preferred embodiment, nickel is used for inner support 130 because of its advantageous properties, e.g., hardness, and the gold outer surface 120 is plated on the nickel inner support 130.

Alternatively, the entire temperature probe 116 may be formed of gold or a gold alloy (not shown). In this embodiment, the gold should be of a composition such that it is hypoallergenic, but also has adequate structural properties for use in temperature probe 116 of thermometer 100.

The types of gold used for the temperature probe 116 can be pure gold, or a gold alloy. Pure gold is very soft and must be thick to have enough hardness to sustain a theoretical maximum biting force of the patient. A thick temperature probe 116 can be used but can increase the size of the temperature probe 116 and cost more to manufacture.

Gold is mixed with other metals to make gold alloy which has a higher hardness than pure gold. Gold alloy is typically identified by a “karat” purity, e.g. 9, 14, 18, and 22 karat. A karat denotes 1/24th, i.e., one part in 24 or 41.66 parts per 1000. Thus, 9 karat gold must be at least 9 parts gold out of 24, which is equivalent to 37.5%, and other metals make up the remaining 62.5%. Similarly, 18 karat gold contains 75% gold ( 18/24) and 24 karat gold is pure gold. The most common metals to alloy with gold are copper and silver, but nickel, palladium, zinc, and other metals are used. Several formulations for gold alloys are set out in Table 1.

TABLE 1
Percentages by Weight

| Alloy | Gold | Silver | Copper | Zinc | Nickel | Palladium |
|---|---|---|---|---|---|---|
| 9 Yellow | 37.5 | 10.0 | 45.0 | 7.5 | 0.0 | 0.0 |
| 9 White | 37.8 | 0.0 | 40 | 10.4 | 11.8 | 0.0 |
| 14 Yellow | 58.5 | 43 | 1.2 | 6.3 | 0.0 | 0.0 |
| 14 White | 58.5 | 0.5 | 27.0 | 7.0 | 7.0 | 0.0 |
| 18 Yellow | 75.0 | 16.0 | 9.0 | 0.0 | 0.0 | 0.0 |
| 18 White | 75.0 | 4.0 | 4.0 | 0.0 | 0.0 | 17.0 |
| 22 Yellow | 91.7 | 5.5 | 2.8 | 0.0 | 0.0 | 0.0 |
| 24 | 100.0 | 0.0 | 0.0 | 0.0 | 0.0 | 0.0 |

In the present invention, an embodiment uses copper, silver or zinc as the alloy metal with gold, and not nickel. Typical allergies to gold stem from low karat gold with a nickel alloy. High karat gold, e.g., 18 and 22 karats, contains a high percentage of gold in the alloy to minimize the effects of the additional metal. Further, alloys using copper and silver bind better with higher percentages of gold and typically cause few to no allergic reactions. One embodiment of the invention uses gold with less than 0.05% nickel by mass, meeting the European requirement of being nickel-free.

Further, alloy gold is harder than pure gold. Table 2 below outlines the Vickers Hardness for various gold alloys identified by the karat of the gold;

TABLE 2

| Alloy | Hardness as Cast | Maximum Annealed Hardness |
|---|---|---|
| 9 | 70 to 105 | 160 to 170 |
| 14 | 125 to 165 | 150 to 180 |
| 18 | 85 to 125 | 170 to 230 |
| 22 | 70 | 60 to 90 |
| 23.75 | 40 | 70 |

As shown in Table 2, typical 18 karat gold alloy has a Vickers Hardness, once annealed, which is two to three times harder than (almost) pure gold. The higher the hardness, the better the gold tip withstands biting forces.

In an embodiment, due to its high gold content, lack of nickel as an alloy metal and high hardness, 18 karat yellow gold can be used for the gold outer surface 120. 18 karat gold provides a high gold ratio, but not as high as 22 karat so it is less expensive. Further, 18 karat gold has a lower cast hardness than 14 karat gold, thus improving its workability in manufacturing the temperature probe 116.

The temperature sensing element 102 is disposed within the thermometer 100 adjacent to a surface of temperature probe 116. Temperature probe 116 may contain an indent or bore 150 extending in from proximal face 122 and temperature sensing element 102 may be placed within the indent or bore 150, as shown in FIG. 4.

The hypoallergenic gold covered temperature probe is not limited to use in oral thermometers. Those with metal allergies have a reaction when allergenic metals contact any exposed surface of their bodies. Thus, a temperature probe with an outer surface of gold is also advantageous for use in rectal and axillary thermometers.

An embodiment of the invention can be used for a gold covered temperature probe of a glass-tube thermometer. A temperature sensing end of a glass-tube thermometer may include a gold cap placed over the glass. The use of a gold cover over the glass helps decrease the thermal resistance between the user and the mercury while retaining the hypoallergenic properties of conventional glass-tube thermometers.

While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

We claim:

1. A hypoallergenic temperature probe comprising:
an outer surface formed of a hypoallergenic gold alloy wherein the gold alloy is provided on areas of the outer surface which come into contact with a user.

2. The hypoallergenic temperature probe of claim 1, further comprising an inner support formed of a different material than that of the outer surface.

3. The hypoallergenic temperature probe of claim 2, wherein the gold alloy is provided on a surface of the inner support.

4. The hypoallergenic temperature probe of claim 1, wherein the gold alloy is 18 karat gold.

5. The hypoallergenic temperature probe of claim 1, wherein the gold alloy includes gold and at least one of silver, copper, zinc and palladium.

6. The hypoallergenic temperature probe of claim 1, wherein the gold alloy includes gold and at least one of silver, copper, zinc, palladium and nickel.

7. A hypoallergenic thermometer comprising:
a temperature sensing apparatus to indicate a temperature of a patient; and
a temperature probe for contacting the patient, the temperature probe including an outer surface formed of a hypoallergenic gold alloy.
